(19) United States
(12) Patent Application Publication
(10) Pub. No.: US 2018/0217287 A1
(43) Pub. Date: Aug. 2, 2018

(54) LOCATING-DEVICE PROBE ASSEMBLY

(71) Applicant: OKM GMBH, Altenburg (DE)

(72) Inventors: Ingolf Müller, Fockendorf (DE); Andreas Krauss, Fockendorf (DE)

(21) Appl. No.: 15/562,505

(22) PCT Filed: Jan. 25, 2016
(86) PCT No.: PCT/EP2016/051424

§ 371 Date: Jan. 10, 2018

(30) Foreign Application Priority Data
Mar. 3, 2015 (DE) 102015004069.3
Jul. 24, 2015 (DE) 102015213985.9

(51) Int. Cl. G01V 3/10; G01V 3/165

(52) U.S. Cl. CPC G01V 3/104; G01V 3/165

(57) ABSTRACT

The invention relates to a locating-device probe assembly including a plurality of non-magnetic hollow profile segments which are joinable to form a probe assembly, wherein at least two sensors are installed at a distance in the hollow profile segments, wherein the hollow profile segments include a base profile element made from telescoping partial profile elements that are retractable into and extensible from the base profile element at both ends, wherein at least one respective sensor is located in an end segment of each outermost partial profile element of the partial profiled elements and a cross-sections of the partial profile elements and of the base profile element have a cross-sectional area that is not circular or rotationally symmetrical.

The invention relates to a locating-device probe assembly including a plurality of non-magnetic hollow profile segments which can be joined in order to form a probe assembly, wherein at least two sensors are installed at a distance from each other in the hollow profile segments according to the preamble of claim 1.

DE10 2013 010 962A1 discloses a locating-device probe assembly including plural non-magnetic hollow profile sections, in particular tubes wherein transmitter and receiver coils are arranged in an interior of the tubes or the respective hollow profile section and plural hollow profile sections with transmitter and receiver coil sections can be assembled to form a three dimensional probe.

With this respect electrical plug contacts or complementary contact jacks are provided at the respective face ends of the hollow profile sections in order to connect the transmitter and receiver coil sections to form a coil arrangement. Furthermore devices for bolting adjacent hollow profile sections together are provided in the portion of the plug in contact and the contact jack in order to join the three dimensional structure wherein the respective electrical connection can be established simultaneously with implementing the bolted connection for mechanically fixing the hollow profile sections. In one embodiment of the probe assembly according to DE 10 2013 010 962 A1 support lobes for the probe can be provided at an outside in particular the outer circumference of the hollow profile section but also skids or similar devices.

In the arrangement for operating a geophysical locating device by processing magnetic field variations so called flux gate sensors and amplifier circuits and a processing and display unit are being used. In an arrangement of this type which is described in DE 10 2004 059 199 A1 a tubular probe includes two offset flux gate sensors that are oriented in an identical direction wherein the sensors provide output voltages with identical polarity. A position of the flux gate sensors in the probe tube is predetermined wherein a compromise between resolution and detection with has to be found with reference to a distance and position of the sensors when operating a probe of this type.

The device for locating metal elements with a probe assembly and a support device that supports the probe assembly according to EP 0 957 377 A2 includes at least two coils. One of the coils serves as a transmitter and another coil serves as a receiver. The support device is connected with a transversal beam. Longitudinal beams are arranged at the transversal beam at a distance from its ends wherein the transversal beams receive the coils in turn.

In an embodiment according to EP 0 957 377 A2 the coils are pivotably arranged at the transversal beam. The transversal beam itself can have a variable length wherein the variability is implemented by moving the first and/or the second linked joint in a linear manner. Due to the particular arrangement of the transmitter and receiver coil with respect to the support device various searching tasks can be covered with the same probe arrangement wherein also a base distance of the search coils can be varied as a function of the searching task in addition to the electromagnetic coupling.

Therefore it is an object of the invention to provide an improved locating device probe arrangement including plural non-magnetic hollow profile sections which are joinable into a probe assembly, wherein at least two sensors, in particular flux gate sensors can be inserted with an offset into the hollow profile sections.

This probe arrangement according to the invention shall provide a variable easily adjustable probe which is easily adaptable to the respective search tasks or the local conditions. In order to quickly examine also large surfaces the probe assembly shall be adjustable to a maximum width, this means to a large distance of the sensors used, wherein a distance of the sensors and a probe length can also be shortened in a simple manner in order to achieve a very high resolution. Using this locating device probe assembly helps to do without a probe replacement which is otherwise often required.

The object of the invention is achieved with the feature combination according to patent claim wherein the dependent claims include at least useful embodiments and improvements.

Accordingly a locating device probe assembly is proposed which includes a plurality of non-magnetic hollow profile sections that are joinable to form a probe. The hollow profile sections include at least two sensors. These are in particular but not exclusively flux gate magnetic field sensors.

The probe assembly according to the invention includes a bas profile. Partial profiles are provided on both sides of the base profile and can be pulled out from the base profile and pushed back into the base profile, wherein respectively at least one sensor is provided in the end section of the outermost extensible partial profile and the cross sections of the partial profiles and of the base profile have a cross sectional surface that differs from a circular or rotation symmetrical cross section.

The telescope arrangement corresponds to a classic telescope wherein the innermost telescope profile represents the outermost portion of the telescope arrangement in pushed together condition when the telescope length is fully extended.

A device for mechanically or electrically coupling a probe support rod or a support handle is arranged in the base profile or at the base profile. This can be an interlocking arrangement, a threaded arrangement or similar for clamping a support rod or similar.

The electrical connection between the sensors that are in the hollow profile section and at a central connecting point at the probe is provided by a flexible cable, in particular a coiled cable.

In an advantageous embodiment of the invention the cross sectional surface of the profiles is implemented rectangular or elliptical. With respect to the different dimensions in the longitudinal direction and in the in transversal direction resulting from the rectangular or elliptical cross sectional surface, thus with reference to the ratio between main axis and transversal axis for an elliptical shape, the employed sensors which have a preferred direction can be arranged in a reproducible and exact manner, this means error tolerant on the assembly side. Furthermore the special configuration of the profile of the individual telescope that is also visible from the outside provides an easily comprehensible reproducible optimum position of the probe above ground that is to be selected respectively.

In one embodiment of the invention the individual profiles are made from half shells which are connectable in a form locking or friction locking manner by a joining process. Alternatively the profiles can also be bonded together.

The respective free end of the end section of the outermost of the telescopable partial profiles is closed by a cap wherein the cap of an embodiment of the invention includes a protrusion that is oriented essentially perpendicular to the longitudinal axis of the probe arrangement for operating the probe at a defined distance above ground.

The profiles of the telescopes are provided with suitable sealing devices in order to prevent a penetration of moisture, dirt or other interfering particles.

The locating device probe assembly provides the option to implement a length differential in a range of 500 mm to 1,500 mm through the partial profiles that are extendable in a telescoping manner.

The partial profiles can be configured self-hemming with respect to their telescoping feature or they can include an interlocking feature when predetermined positions are reached.

In an advantageous embodiment of the probe assembly according to the invention the signals generated by the sensors are optionally preprocessed, transmitted in a wireless manner to a processing device that is spatially separate from the probe assembly.

In an advantageous embodiment of the invention the hollow profile sections of the probe assembly are produced from a plastic material so that a cost effective implementation of the individual components of the probe assembly is provided.

The invention is subsequently described based on an embodiment and with reference to drawing figures, wherein:

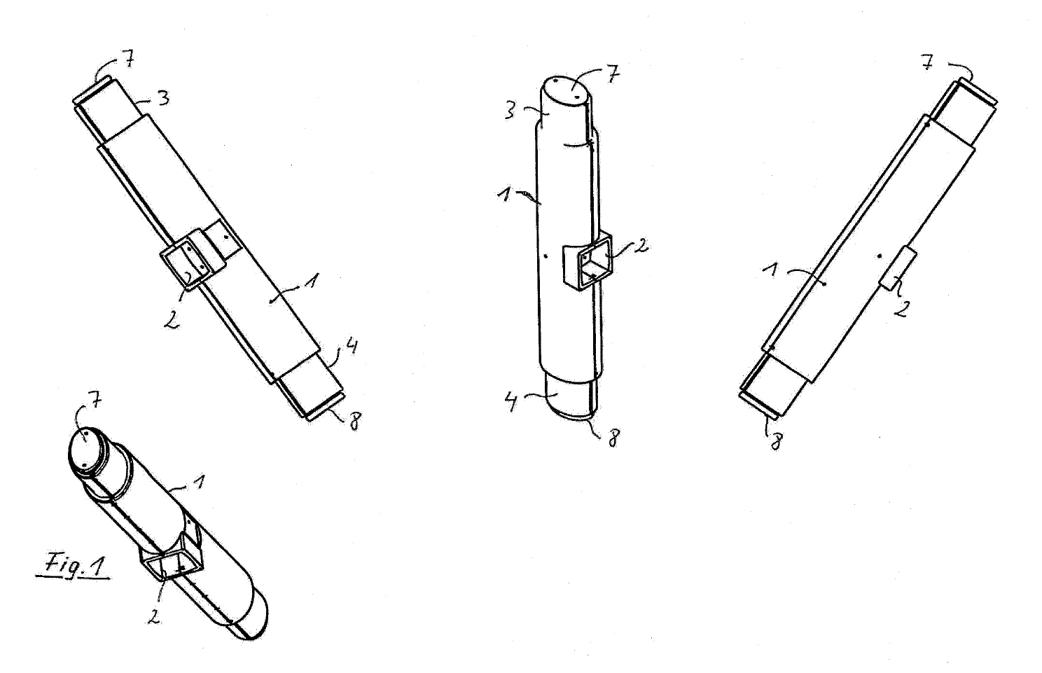

FIG. 1 illustrates several views in different perspectives of the locating device probe assembly with completely inserted partial profiles, this means disposed in the base profile, wherein a total longitudinal dimension of the assembly is in a range of approximately 500 mm in this condition where the telescopes are completely inserted.

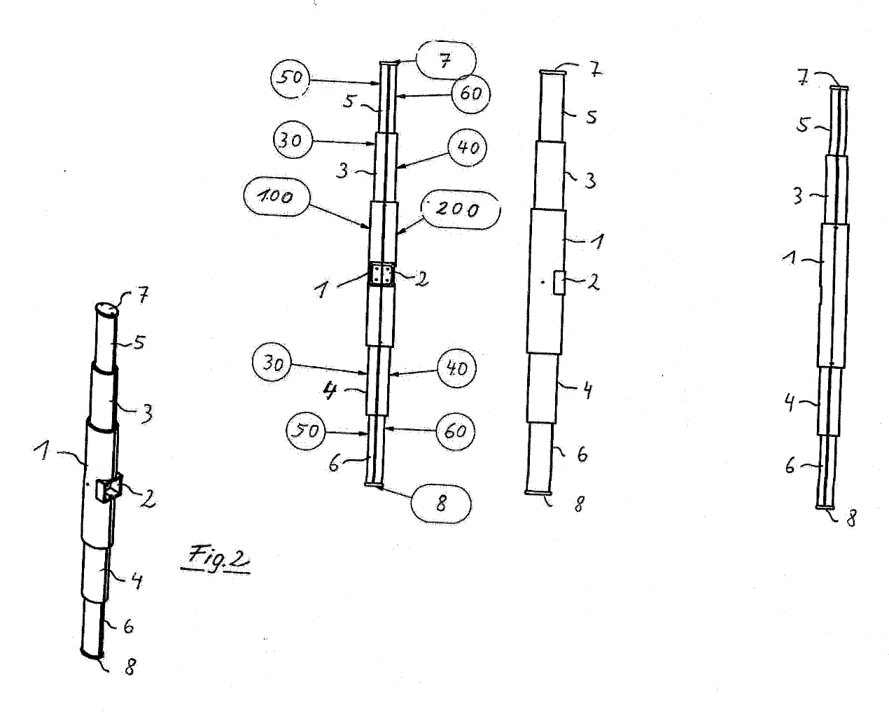

FIG. 2 illustrates plural views in different perspectives of the locating device probe assembly in completely extended condition where all partial profiles are in a position so that a maximum length of approximately 1200 mm is achieve able.

The locating device probe assembly as illustrated in FIGS. 1 and 2 is made from a base profile 1 which includes a receiver 2 for mechanically and/or electrically connecting a non-illustrated probe support rod or support handle.

The base profile 1 is formed from two half shells 100; 200 as indicated in FIG. 2.

The base profile 1 receives respectively two dimensionally adapted partial profiles 3 and 4 through its open sides which are respectively made from half shells 30 and 40.

Additional telescope partial profiles 5 and 6 are arranged in an interior of the partial profiles 3; 4 wherein the telescoping partial profiles 5 and 6 are made in turn from half shells 50 and 60.

The outer ends of the partial profiles 5; 6 are closed by a cap 7 or 8.

It is evident from the illustrations that the cross sectional surface of the profiles is advantageously configured elliptical.

In pushed together condition of the probe arrangement according to the illustrations according to FIG. 1 a very high resolution is implementable by the sensors arranged in an interior of the hollow profile sections.

When illustrating the completely extended, this means completely telescoped probe assembly according to FIG. 2 a very wide search track is scanable or provided when running the respective probe over the ground, so that also larger terrain sections can be detected at least in a coarse manner. When this coarse search indicates an object of interest the probe can be pushed together without great complexity in order to optimize the resolution and a more detailed search can be performed at the chosen location.

1. A locating-device probe assembly, comprising:
a plurality of non-magnetic hollow profile segments which are joinable to form a probe assembly, wherein at least two sensors are installed at a distance in the hollow profile segments,
characterized in that the hollow profile segments include a base profile element (1) made from telescoping partial profile elements (3; 4; 5; 6) that are retractable into and extensible from the base profile element at both ends,
wherein at least one respective sensor is located in an end segment of each outermost partial profile element of the partial profiled elements (5; 6) and a cross-sections of the partial profile elements and of the base profile element have a cross-sectional area that is not circular or rotationally symmetrical.

2. The locating device probe assembly according to claim 1, characterized in that
a device (2) for mechanically and/or electrically connecting a probe support rod or support handle is provided at the base profile element (1).

3. The locating device probe assembly according to claim 1, characterized in that
an electrical connection between the sensors and a central connecting point at the probe is provided by a coil cable or a similar device.

4. The locating device probe assembly according to claim 1, characterized in that
the cross sectional surface of the profile elements is rectangular or elliptical.

5. The locating device probe assembly according to claim 1, characterized in that
the profile elements are made from half shells (30; 40; 50; 60; 100; 200) which are connectable in a form locking or friction locking manner by a joining process.

6. The locating device probe assembly according to claim 1, characterized in that
the free end of the end section of the outer most of the extensible partial profiles (5, 6) is closed by a cap (7; 8).

7. The locating device probe assembly according to claim 6, characterized in that
the cap (7; 8) includes a protrusion that is oriented essentially perpendicular to a longitudinal axis of the probe assembly for supporting the probe at a defined distance above ground.

8. The locating device probe assembly according to claim 1, characterized in that
a length variability is implementable by the telescoping extensible partial profiles in a range of essentially 500 mm to 1500 mm.

9. The locating device probe assembly according to claim 1, characterized in that
the partial profiles are configured self-hemming with respect to their telescoping ability or they have an interlocking feature when reaching predetermined positions.

10. The locating device probe assembly according to claim 1, characterized in that
signals generated by the sensors are transmitted in a wireless manner to a processing unit that is spatially separated from the probe assembly.
